(19) United States
(12) Patent Application Publication
(10) Pub. No.: US 2005/0039014 A1
(43) Pub. Date: Feb. 17, 2005

(54) Electronic security system for monitoring and recording activity and data relating to persons

(75) Inventor: James M. Sajkowsky, Pennington, NJ (US)

Correspondence Address: J. Kevin Grogan, Esq.;McCormick, Paulding & Huber LLP, CityPlace II, 185 Asylum Street, Hartford, CT, 06103, US

(73) Assignee: UNITED SECURITY APPLICATIONS ID, INC., East Windsor, NJ (US)

(21) Appl. No.: 10/871,267

(22) Filed: Jun. 17, 2004

Related U.S. Application Data
(60) Provisional application No. 60/479,127, filed on Jun. 17, 2003.

(51) Int. Cl. H04L 9/00

(52) U.S. Cl. 713/172

(57) ABSTRACT

An apparatus for providing secure and unique identification of individuals includes a device for electromagnetically recording and storing data indicative of a specific individual. The device receives and stores data in various fields. A system for use in tracking and identifying individuals includes an electromagnetic identification device that has a plurality of data fields, each being adapted to receive identifying signals; a writer for encoding the signals into the appropriate data fields; a controller for receiving signals uniquely identifying an individual and storing the signals in a master database; and a reader adapted to interrogate the unique individual identification signals stored on the electromagnetic identification apparatus and for comparing corresponding individual identification signals with signals received from the electromagnetic identification apparatus and generating an alarm signal if a discrepancy exists.

### CROSS-REFERENCE TO RELATED APPLICATIONS

This application claims the benefit of U.S. Provisional Application No. 60/479,127, filed Jun. 17, 2003, entitled “Electronic Security System For Monitoring and Recording Activity and Data Relating to Persons and Goods”; and further relates to a co-pending application entitled “Electronic Security System For Monitoring and Recording Activity and Data Relating to Cargo” (Attorney Docket No. 5264-0002-2) filed concurrently herewith; and further relates to a co-pending application entitled “Electronic Security System For Monitoring and Recording Activity and Data Relating to Institutions and Clients Thereof” (Attorney Docket No. 5264-0002-3) filed concurrently herewith, all of the fore-mentioned applications being hereby incorporated by reference in their entireties.

### FIELD OF THE INVENTION

The present invention relates to systems and methods of electronically monitoring and recording data and activity with respect to persons and, more particularly, to a system that monitors and records dynamic real-time data related to individuals, with particular application to travelers in the context of providing security.

### BACKGROUND OF THE INVENTION

It is known to provide personal identification and information storage processing systems which store data in electronic form and similarly process and transmit data with respect to individuals in many contexts of regulation and business. There are, for example, portable microprocessor devices including computers, “smart cards” with microchips, and electronically scanned labels or bar codes, light and radio sensors, and other technologies used to accomplish these purposes.

Typically, devices that store, process, and transmit data are linked in any one of a variety of ways to create a computer-based network that communicates with input and output devices to store and process data on individuals. For example, these networks include the Internet and World Wide Web and private networks. Transmission of data signals can be achieved via modem, cable, radio frequency (RF) transmission, or the like.

While there are numerous examples in business and society at large of systems and methods for obtaining, storing, and processing communication data using these known hardware and software technologies, there is no system currently existing for obtaining, managing, processing, and communicating data signals that effectively track people moving in and out of several countries. Moreover, there lacks any apparatus to effectively link such communication in real time among the various government agencies and authorities in a cooperative and useful manner.

Currently, the various state and local agencies in the Unites States have generated a series of different photographic identification cards which contain printed information, now including a person's photo. These most typically include driver's licenses issued by each of the 50 states and territories. Similarly, many states have requirements for obtaining firearm permits and likewise require an additional card which contains relevant information about the individual and which class of firearms the person is permitted to carry. Many companies likewise will issue photo identification cards for use in their respective businesses. These photo identifications contain printed material only in large part, that is, name, address, date of birth, eye color, etc., along with a picture. There are some identification cards used in industry, which contain more information such as a thumbprint or the like.

None of the systems currently in place for identifying people take advantage of new technologies which have been used to identify and track the shipment of goods, such as bar codes or the like, nor is there an effectively standardized and tamperproof identification system for individuals at present. This lack of unified approach to personal identification was sufficient in the past because most identification was used for simple operations such as identification to police officers during routine traffic stops, check cashing, and the like. Foreign governments have their own system of identification complete with security measures, which vary widely in their effectiveness. There is currently great controversy whether Mexican individuals in the United States can rely on their Mexican identification cards for similar identification purposes here in the United States.

The current problem is exacerbated by the vast numbers of people entering and exiting the United States with the current technologies used to create photo identification. There is simply no effective mechanism in place to allow for a systematic and substantially secure mechanism for identifying and tracking individuals as they move about the United States. As a result of the tremendous breach of Homeland security, which occurred on Sep. 11, 2001, and the ongoing hostilities on terrorists abroad, the current systems for identification are completely inadequate. Currently, the United States has revamped application procedures for visas for foreigners, applications for passports, as well as attempted to come up with some improved security measures for the creation of the documents. What is needed is a system that allows for the tracking of persons entering, traveling in, and exiting the United States so as to limit or prevent the opportunity for wide scale security breaches. Furthermore, a system is needed that facilitates the exchange of information between authorized users of the system.

### SUMMARY OF THE PRESENT INVENTION

In one aspect, the present invention is directed to an apparatus for use in providing for the secure and unique identification of persons. Such an apparatus includes a device for electromagnetically recording and storing data and identifying parameter values indicative of a specific individual. Preferably, the device is capable of receiving and storing data in a plurality of fields including an identifier field adapted to receive signals identifying a particular individual only from permitted sources and a travel field adapted to receive signals corresponding to data related to a sequence of travel.

In another aspect, the present invention is directed to a system for use in tracking and identifying individuals. Such a system includes an electromagnetic identification device that has a plurality of data fields, each of the data fields being adapted to receive signals which uniquely identify an individual; a writer for use in encoding the identification signals into the electromagnetic identification apparatus data fields; a controller for receiving signals uniquely identifying an individual and storing the individual identification signals in a master database storage apparatus; and a reader adapted to interrogate the unique individual identification signals stored on the electromagnetic identification apparatus and for communicating with the controller for comparing corresponding individual identification signals stored on the master database storage apparatus with signals received from the electromagnetic identification apparatus and generating an alarm signal should the comparison reveal a discrepancy.

### BRIEF DESCRIPTION OF THE DRAWINGS

FIG. 1 is a schematic diagram of an electronic identification system for an individual identification system.

FIG. 2 is a schematic diagram of the system of FIG. 1 in which identifying information is written to a system comprising multiple cards.

FIG. 3 is a plan view of an identification card of the present invention.

FIGS. 4 and 5 are perspective views of a handheld reading device capable of being utilized with the electronic identification system of the present invention.

FIG. 6 is a simplified flow diagram illustrating a process in which a person traveling enters an airport or checkpoint such as a border station with an electronic identification card.

FIG. 7 is a simplified flow diagram illustrating the linking of an electronic identification card with various databases.

FIG. 8 is a simplified flow diagram illustrating the tracking of the departure of a visitor from a foreign country.

FIG. 9 is a simplified flow diagram illustrating the tracking of the return of a U.S. citizen from a foreign country.

FIG. 10 is a simplified flow diagram illustrating the tracking of a ticketed person on domestic travel via a carrier.

FIG. 11 is a simplified flow diagram illustrating the issuance of a smart visa to a first-time foreign visitor.

FIG. 12 is a simplified flow diagram illustrating the procedures for travel by a foreign visitor using a previously issued smart visa.

FIG. 13 is a simplified flow diagram illustrating the issuance of a new smart passport (or the renewal thereof) to a U.S. citizen.

FIG. 14 is a simplified flow diagram illustrating the updating of a conventional passport to a smart passport for a U.S. citizen.

FIG. 15 is a simplified flow diagram illustrating the issuance of a national identification card.

### DETAILED DESCRIPTION OF THE PREFERRED EMBODIMENT

The present invention is directed to a secure identification card for individuals and a system for using such a secure identification card. The card is especially adapted to be used with a system that allows for the tracking of individuals, specifically foreigners, entering the United States and allowing for the determination of status instantly by electronic communication in real time with a master database.

The present invention contemplates an integrated system of identification card(s), passports, visas, and similar identifying devices that are cooperative with a central system capable of being accessed by various government agencies including, but not limited to, the Federal Bureau of Investigation (FBI), the State Department, the Department of Defense, immigration authorities, customs personnel at ports of entry into the United States, state and local police departments, and the like.

One key aspect of the present invention is the use of identification card(s) for all persons in the United States. Such cards include visually ascertainable identifying information but may further include a digitized photograph, a biometric fingerprint, and coded information. In one embodiment, the coded information is electronically stored in a microchip that is embedded in the structure of the card itself. Furthermore, the coded information may be in a form having emitting and receiving capability or similar transmitting/receiving functions (e.g., by radio frequency (RF)) so as to facilitate the automatic reading of data programmed into the microchip in the card. In any embodiment, the digitized photograph allows the system to be used with facial recognition systems (facial printing). The biometric fingerprint allows for a quick resolution of an identity verification query via fingerprinting techniques and databases. The coded information is readable by a reader and is linked to a centralized database containing a record of the permanent information relating to the cardholder. The card is preferably made tamperproof by encasing the identification mechanisms (e.g., via lamination techniques), incorporating a holographic image into the card, and/ or encrypting the coded information.

Another key aspect of the present invention is the use of the identification card as a “smart” passport for persons travelling in and out of the United States. As is used herein, the term “smart,” when used to describe the apparatuses of the present invention, is intended to mean that data can be written to, stored on, erased from and rewritten to, and retrieved from the apparatuses using applicable devices. Use of a smart passport incorporates “watch” technology that enables a government to track and monitor any smart passport holder in any readable environment and particularly as the smart passport holder moves into, through, or out of a secure area such as a border checkpoint, an airport, a shipping port, or even a monitored building or area. The card itself contains the relevant data, which is substantially the same as that stored on a master database.

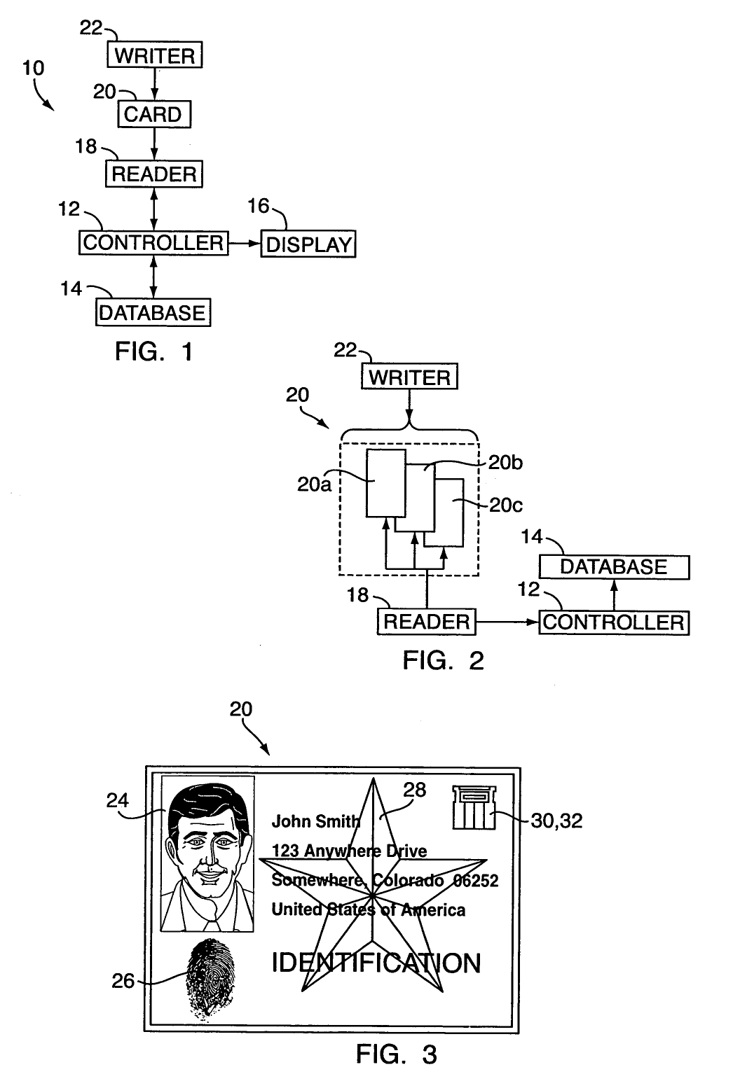

Referring to FIG. 1, one exemplary embodiment of a system for a secure identification card system 10 for individuals has a controller 12, a database 14, a display apparatus 16, a reader 18, at least one card 20, and a write apparatus 22. Each individual is given his or her own card. In a preferred embodiment, the controller 12 is a host computer capable of setting forth the operations as disclosed hereinafter and having sufficient memory so as to provide for the proper processing of information received from the reader 18 and its display. The card 20 is preferably a smart identification device that includes information specific to the holder of the card, such information preferably being the digitized photograph of the holder, the biometric fingerprint of the holder, and the microchip.

Referring now to FIG. 2, the card 20 is shown illustrating three separate cards 20a, 20b, and 20c for three separate people. Although only three cards are shown, it should be understood that any number of cards may be used with the system. Preferably cards are issued to every person residing and/or traveling in the U.S. As detailed hereinafter, the read/write functions for the cards are strictly controlled, usually only by an issuing authority.

Each card 20a, 20b, and 20c preferably stores data that is unique to the holder of the card. Referring to FIG. 3, data stored on the card 20 preferably includes a digitized photograph 24, a biometric fingerprint 26, a holographic image 28, and an internal memory chip 30 that contains encoded data. Examples of data that can be encoded in and stored on the microchip include, but are not limited to, driver's license information (e.g., identification numbers, vehicle registration data, and infraction histories), social security numbers, addresses (past and current), personal data (e.g., date of birth, height, weight, hair color, and eye color), electronic- and telephone contact information, medical records (e.g., allergies, medications, substance abuse histories, the presence of any types of prosthetic devices (which may be useful in determining why a person cannot pass through a metal detection device without triggering an alarm), or other health information), criminal records (e.g., felony-, misdemeanor-, sexual offender statuses, prior convictions, acquittals, and the like), aliases, genealogical data (e.g., next-of-kin contact information or other data that may be useful in determining a person's whereabouts), financial and banking information (e.g., credit card numbers and credit limits, checking- and savings account numbers and balances, credit histories and ratings, salary histories, and the like), firearm purchase and ownership records, marital statuses, political party affiliations, indications of ethnic backgrounds and citizen statuses, work- and unemployment histories, education histories, library records, consumer purchase histories, property ownership and lien information, legal judgments, information and histories pertaining to the receiving of welfare and other government benefits, insurance verification, and the like.

In one embodiment, the internal memory chip 30 of the card 20 typically comprises an EEPROM with 1,024 bits total memory. Byte boundary memory addressing and byte boundary memory lock are used. The communications platform used to receive data from the memory chip 30 is preferably an anti collision protocol binary tree-type, anti collision algorithm. In addition, the information programmed into the memory chip 30 can include global location numbers, the date and time of card activation, customs harmonizing codes, harmonizing code descriptions, and the like. Port entry and exit identification data can also be written to the cards as they pass through entry and exit ports, such data being comparable to corresponding data retained by Customs at the entry and exit ports for the purposes of verifying travel and system operation as necessary.

The card 20 may optionally include a signal device 32 that can be any suitable electromagnetic transceiver. In one embodiment, the signal device is an Intermec 915 MHz radio frequency identification (RFID) device, which has a passive operation and is EPC (electronic product code) and ISO (International Standards Organization) compliant. Such a device has a read range of up to about 13 feet and is mountable on an adhesive strip and can further double as a human readable label as well.

The card 20 with the RFID signal device 32 can be read by a reader 18. In the preferred embodiment, the reader has the capability to query and read the signal device 32 on each card 20 view data from cards, write card data, and clear and rewrite card data as applicable. Several readers 18 can communicate as part of a single network. The preferred system uses an Intermec ITRF91501 reader, which is a 915 MHz fixed reader and card writer having four (4) address antenna ports, an RS232 serial port, and the capability of reading an RFID signal device within twelve milliseconds and performing a verified write at an average of 31 milliseconds per byte per card. Such a device reads at a distance of about 3 meters with a single antenna.

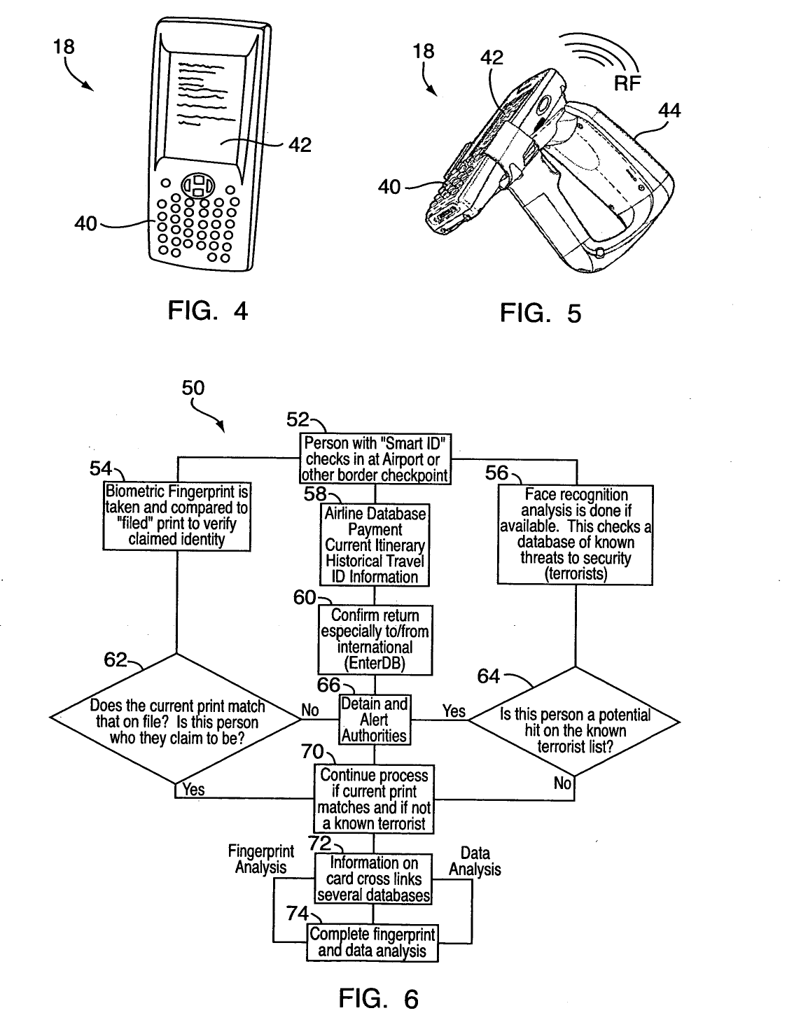

Alternatively, the reader 18 may be an Intermec IP3 portable reader used by personnel at a remote location. Referring now to FIGS. 4 and 5, the Intermec IP3 is seen to have mobile read/write capability and includes an Intermec 700 series mobile computer. Reading operations are effected by an internal circularly polarized antenna powered by a rechargeable lithium ion battery pack, and the computer powers the system application to process the RFID signal data. An alphanumeric keypad 40 and a screen 42 facilitate input/output communication from and to a user. The portable reader is built for indoor and outdoor use and has an operating temperature of +14° to +140° F., is rain- and dust resistant, IP64 compliant, powered by lithium ion 7.2 volt batteries, and uses Microsoft Windows for Pocket PC as an operating system. There is either 64 megabytes or 128 megabytes of random access memory (RAM) and flash read only memory (ROM) of 32 megabytes. The internal slots have a secure digital and a compact flash (CF) Type II card. It relies on a standard communication protocol of RS232, IrDA1.1 (115 kilobytes per second (KBPS)). Ten (10) base T-Ethernet and USB port configurations of the reader are available. There are integrated radio options and integrated scanner options for the reader as well. Preferably, the reader 18 can be accommodated by a docking station 44 to provide desktop connectivity.

At any time, an authorized user (having a unique user identifier or password and meeting established security requirements) can read a file from the card 20 using the reader 18 to ascertain the data programmed on the card 20. In a preferred embodiment of the present invention, the read file can be copied or transferred to a computer or other control device (e.g., a laptop computer, a desktop computer, or a personal digital assistant (PDA)). Information from the card 20 may be generated, displayed, printed, or transmitted to a central computer for processing. Under a control mechanism (e.g., software), the information from the card 20 can be compared to other information such as results obtained from a facial scan of the card holder to determine if the card holder is the same person that the card 20 was issued to. Reports indicating the accuracy of the data or a breach of security may be printed and/or displayed.

The system 10, as described above with reference to FIGS. 1 through 5, is configured to be computer controllable to collect the data. It easily connects to a PC data control system through a high performance Ethernet network interface cable.

The electronic apparatuses of the system described above are capable of inputting, processing, storing, and transmitting data pertaining to the identification of individuals and linking such data to various terminals via the execution of various algorithms. The data may also be adapted to be cross-referenced with existing databases to provide functions that track individuals at discrete points during travel.

The devices of the system may also be adapted to provide a system for the continuous tracking of individuals. More specifically, by incorporating the RFID signal devices into clothing, bracelets, necklaces, or the like, it is possible to determine movement by continuously polling the RFID device. Such a continuous tracking system may be especially useful in tracking suspected or known criminals or terrorists. It may also be useful in monitoring a prison population. In any scenario, the tracking of individuals may be with or without the knowledge of the individual.

In any use of the system, there is provided for a non-intrusive, remote, wireless monitoring of the locations and movements of individuals. Intermittent polling of the signal device of the system (e.g., the reading of cards) allows the position of an individual to be ascertained at given points for security purposes and further allows for the transfer of relevant information to the proper parties for any purpose. Continuous polling of the signal device of the system allows for the real-time or near-real-time surveillance of an individual, which may be useful in predicting the undesirable congregating of individuals and for making assessments as to the need for police or military action. Preferably, the transmission of the data is integrated via satellite, GPRS (general packet radio service), or cellular applications to provide the real-time or near-real-time analysis.

For non-passport carrying U.S. citizens, the smart passport that incorporates the technology as described herein serves as a national identification card. Functionally, this card is identical to a smart passport issued to a foreigner entering the United States. In the United States, the smart passport for an American citizen preparing for travel abroad, as well as others in this country not doing so, is linked directly to that traveler's social security number and will become the primary means of identification for that traveler when traveling in or returning to the United States.

As a United States citizen preparing for travel abroad applies for and receives the new smart passport, a record is created in a centralized computer system containing the large master database with this printed information. This individual record contains all the typical passport information including, but not limited to, background check, biometric fingerprint, digitized photograph, and itinerary of travel. In certain instances, it can be linked to carrier data sources (e.g., airlines or maritime carriers) and to an RF signal device contained on the card. This database is accessible by authorized government officials at appropriate levels of read only or read-write to preserve the integrity of the information.

Information in this database can be upgraded as necessary. For example, when the individual acquires drivers' license, that information is recorded. If that individual then either receives a motorcycle endorsement or commercial drivers' license, similarly that information likewise is coded into the computer system for storage.

The smart passport would be a document which is also obtained by aliens coming into the United States, including both resident aliens, those having a “green card” and work permit here in the United States, as well as those simply here on business or vacation travel. As the alien traveler enters the country and proceeds through immigration, the smart passport is scanned. The customs officials have full access to the traveler's pertinent background then available on the smart passport. As part of the entry process, the alien traveler enters a thumbprint on a biometric plate. The biometric print obtained at the point of entry is compared to the one stored on the database to ensure that the individual entering the country is indeed the individual that applied for and received that smart passport.

Travelers must declare a length of stay at Immigration as evidenced by a return travel ticket and linkage to a carrier database. This allows again Custom Officials to verify in real time the date and expected port of departure. As the individual completes the stay and leaves via airport, seaport, or border crossing, the corresponding information and thumb print is again taken to verify the person exiting the United States is in fact that person holding the smart passport. This information is provided to the master database. There are algorithms executed by the central computer system which on a periodic basis, every day, every week, etc., will poll the database to confirm that individuals supposedly leaving the United States on that day did in fact do so.

Often time travelers, especially business travelers, may have a change in plans required them to stay an additional length of time. Typically the traveler makes changes with the carrier to affect the same. The present system requires that the airlines, when such a change on a foreign traveler is made, send an electronic notice to the master passport system to allow for an update of the traveler database.

Other embodiments of the present invention allow for seamless communication with private data networks such as are operated by banks, credit card companies, car rental companies, cell phones, etc., as is appropriate to enable for an electronic computerized inspection of the person's activities here in the United States. For example, a suspect individual can be identified by the person's point of entry and subsequent commercial transactions, car rentals, airline tickets and the like, in the United States. This would enable the authorities to quickly track an individual's prior movement in the Unites States to identify suspects or clear certain individuals.

The smart passport system provided by the present invention can be implemented in phases. The first phase would be the incorporation of an RF signal device with the cards. This will allow immigration to immediately track individuals and will alert officials if the traveler does not leave as scheduled. The signal device would be attached using a non-removable sticker on the passport in place of the stamp that countries currently use. The sticker would house the RF signal device.

The second phase would be the implementation of smart passports in other countries. These would replace all the current passports with the signal device enabled smart passport with the digitized photograph and biometric thumbprint. This transition can be implemented over time to ease the cost and allow whatever problems found in implementation to be corrected.

As noted hereinabove, the present invention also has implications for the credit card industry as well. As is well known, credit card misuse and fraud is an enormous problem in this country with approximately 2.5 billion dollars per year being attributed to fraudulent purchases.

In the companion applications filed concurrently and referenced above and owned by the assignee of the present invention, there are disclosed and claimed systems and methods for use in cargo tracking as well as security tracking within institutions. The systems and methods of the present invention can be dovetailed with these other systems to provide security on a full spectrum of people, goods, and institutions throughout the United States.

The smart passport as it would pertain to Americans would include information as listed above as well as other identifying information such as a thumbprint. The smart passport ID card would be issued to new parents and the data pertaining to their newborn would be entered onto a master database. Such data would include name, date of birth, hospital, parental names and addresses, social security number, as well as any other identifying information. Similarly, the ID card can be updated to include the name of schools and addresses that the person attends. University record, graduation dates, and other school information can also be embedded in the card database. As the person ages and begins new endeavors, relevant information can be updated. For example, when the person obtains a drivers license, joins a military service, obtains gun permits and the like, all this information can be updated for either presentation on the card or at least back in the system master database.

Referring to FIGS. 6 through 15, various algorithms by which the system of the present invention operates are shown. The operation of the identification system includes various stages at which different functions occur, the summation of which result in a determination of the identity of a person. Specifically with respect to FIG. 6, there is described a process in which a person traveling enters an airport or checkpoint such as a border station. The traveler has already been provided with an electronic identification (“smart ID”) utilizing electronic storage technology such as “smart cards” or similar means. The smart ID is issued for use as a passport and it contains, electronically stored, similar information as is contained in ordinary passports. The smart ID further includes one or more of a digitized photo that is stored in electronically readable, non-erasable form; a bio-metric fingerprint stored in electronically readable, non-erasable form; other biometric data (e.g., a retinal scan); a signal device (such as RF) with emitting and receiving capability or similar transmitting/receiving means; and like data storage and transfer means known to those skilled in the art. The smart ID is issued in non-erasable form (except for authorized users) and in a manner that allows detection of tampering. Known technology for creating tamper-resistance includes holographic imprinting and encoding. The RF signal device is designed to communicate with read/write equipment located at the border terminals by authorized personnel.

Ideally, all countries would issue a smart ID in accordance herewith. In the absence thereof, a traveler would have to be detained at a checkpoint or border when entering a country utilizing the present invention while a smart ID and profile is created. A traveler entering an airport checkpoint with a smart ID would initiate a check-in process 50. In the check-in process 50, the traveler checks-in at a check-in step 52 and provides (preferably by scanning his card) a biometric fingerprint in a fingerprint step 54. The traveler may also or additionally submit to a facial recognition test in a face-scanning step 56. The data obtained at the checkpoint (“real time data”) is compared to the corresponding airline database data in a check step 58 and/or to data that was entered at the place and time of issuance of the smart ID, and to the corresponding data that is contained in the storage of the smart ID. The data is confirmed in a confirmation step 60. Additionally, the facial recognition data is compared to other data that may have been entered through other means or that is linked to another network, such as a list of individuals known to be a security risk for whom data is available for comparison. Such comparisons ensure that the traveler has represented his or her true identity. From the fingerprint step 54, a query 62 makes a comparison. From the face-scanning step 56, a query 64 makes another comparison. If either comparison reveals that the traveler is on a list of people to be detained, or if the information is not a match and falsifying is suspected, the system that reads and compares the data will automatically issue an alert in an alert step 66. Security can then detain the traveler on that basis. If no such alert is indicated, the procedure continues by running various additional checks, if desired, in a continuation step 70. Such additional checks include, but are not limited to, intelligence watches from law enforcement or other authorized governmental agencies.

At this point in the process, the smart ID downloaded at the checkpoint can be used to access data for airline ticketing and itinerary confirmation in an access step 72. In the access step 72, if a government agency or other authority wishes to monitor the activities of a traveler including whether or not the traveler leaves the country at the time and place indicated in the itinerary, it may do so. If not, an alert can be automatically activated. From the access step 72, fingerprint data and other data are merged and compiled in a compilation step 74.

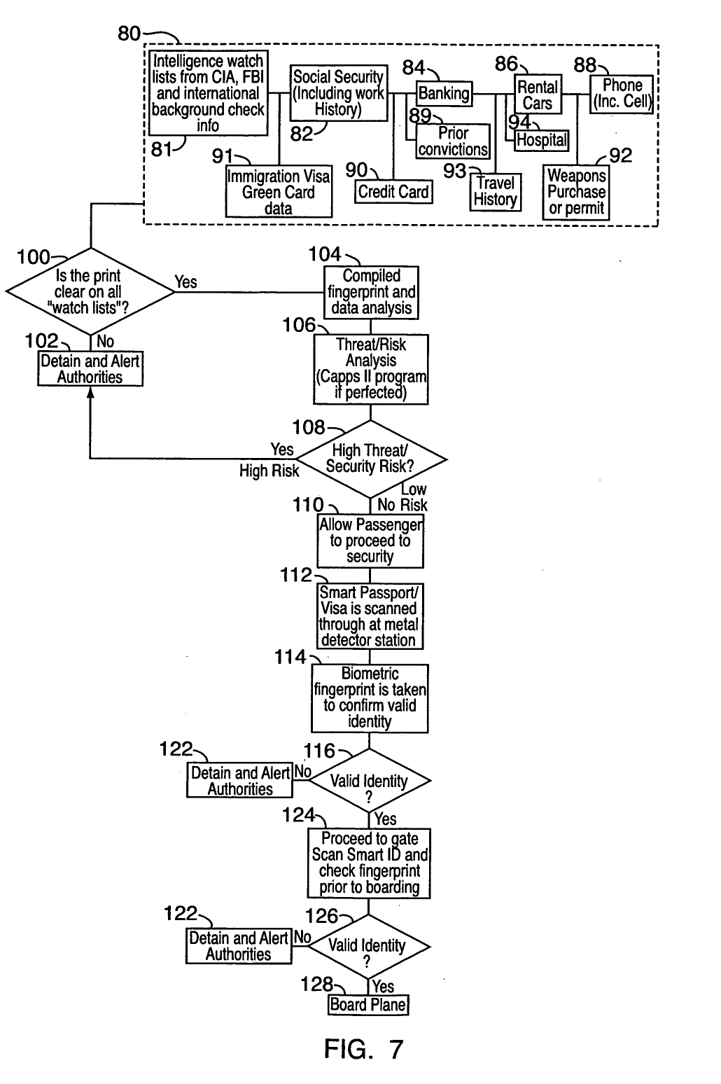

In addition, with reference to FIG. 7, the smart ID can be linked to other databases (shown at 80) to analyze activities that may be indicative of illegal or threatening conditions. Such databases 80 include, but are not limited to, watch lists 81, social security (and work history) databases 82, banking databases 84, car rental databases 86, phone use databases 88, criminal history databases 89, credit card use databases 90, Immigration Visa databases 91, weapons purchase or registry databases 92, travel histories 93, medical records 94,and the like.

A query 100 is executed, and if any of the above-mentioned comparisons are indicative of a programmed alert event, the system automatically alerts authorities in an alert step 102, and the traveler can be detained. If not, the data is compiled in a compilation step 104, a threat/risk analysis step 106 may be executed, and a query 108 may be made as to whether the traveler is a threat or security risk. If the traveler is deemed to be a threat or risk, the alert step 102 is re-executed. If not, the traveler can proceed through a security step 110. The smart ID is scanned through a metal detector station in a detection step 112, the biometric fingerprint is taken in a fingerprint scanning step 114, and a query 116 is made to confirm the identity of the traveler. If the traveler's identity is not confirmed, the traveler is detained and authorities are alerted in an alert step 122. If the identity is valid, the traveler proceeds to a gate in a proceed step 124. In the proceed step 124, the fingerprint and smart ID are re-scanned, a query 126 is executed to determine if the ID is valid. If the ID is not valid, the traveler is detained and authorities are alerted in the alert step 122. If the ID is valid, then the traveler boards the vessel in a boarding step 128.

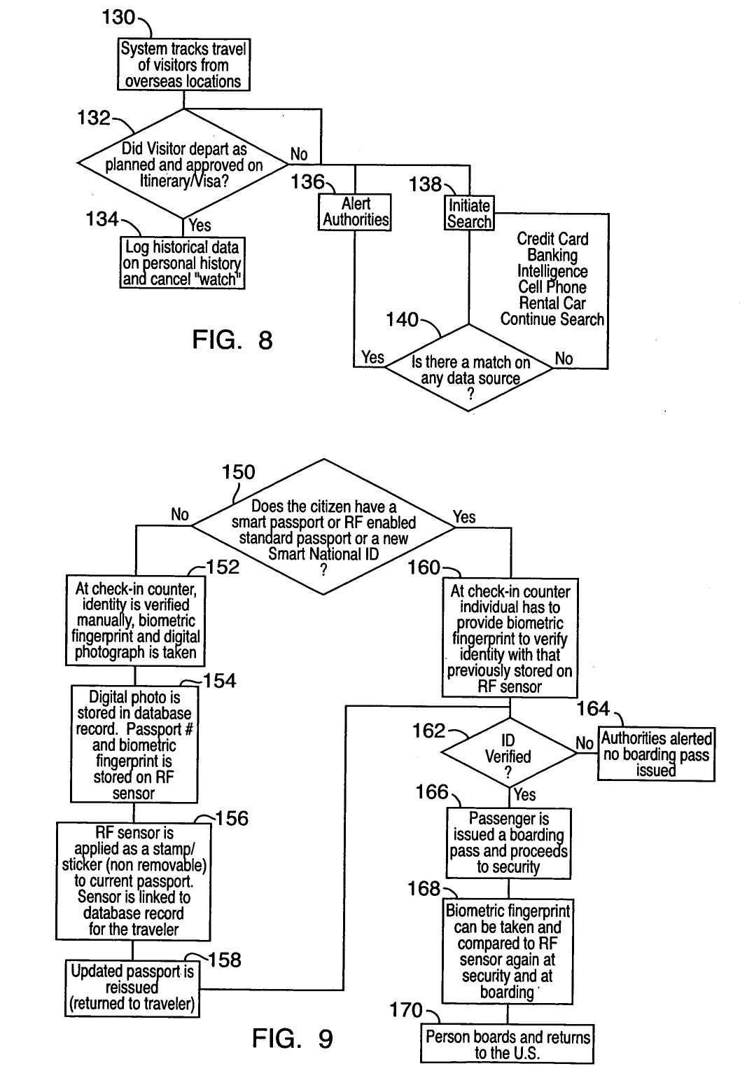

Referring now to FIG. 8, when non-citizen travelers are departing from the country, the smart ID is scanned again at the departure point and the same above-described verification steps are used to prove the identity of the traveler. In a tracking step 130, travel of visitors from overseas locations is monitored and recorded. A query 132 is made to determine if the visitor departed as planned and whether the visitor had an approved itinerary and visa. The system compares the actual departure date to the reported itinerary that was input at the time of arrival into the country. Other comparisons can be made that scan for activities such as banking, telephone use, credit card, rentals and the like that can be pieced together to reflect the activities and places visited by the traveler. If the comparison is ordinary, then all monitored data is logged in a logging step 134. If any of the comparisons produce a preprogrammed discrepancy or indication that merits alert, an automatic alert can be produced in an alert step 136 to alert authorities to detain the traveler prior to departure. A search of the traveler can then be initiated in a search step 138. From the search step 138, a query 140 is executed to determine if there is a match on any existing searched data source. If the comparisons check out, the traveler is approved for departure and the status of his or her identity on the system is taken off watch mode.

When a citizen returns from international travel, as outlined in FIG. 9, the traveler produces the smart ID to verify his identity through the above-described biometric or digital facial and thumbprint means at the international point of departure. A query 150 is made to determine if the traveler has a smart ID or similar device. If he does not, his identity is verified manually in a verification step 152 and his photograph is taken, his digital photograph is stored and other data is stored on his card in a storing step 154, and a signal device (if applicable) is applied in a signal device application step 156. An updated passport is then reissued and given to the traveler in an update step 158. If the traveler does have a smart ID, he is checked in a checking step 160. From either the checking step 160 or the update step 158, a query 162 is executed to verify the traveler's identification. If the identification can not be verified or if there is a discrepancy, the authorities are alerted in an alert step 164. If there is no discrepancy and the traveler can be verified, he is issued a boarding pass in an issue step 166. At boarding time, a biometric scan is again obtained (in a scanning step 168) to compare again to the smart ID and the seat assignment. The traveler then boards the plane bound for his or her home country in a boarding step 170.

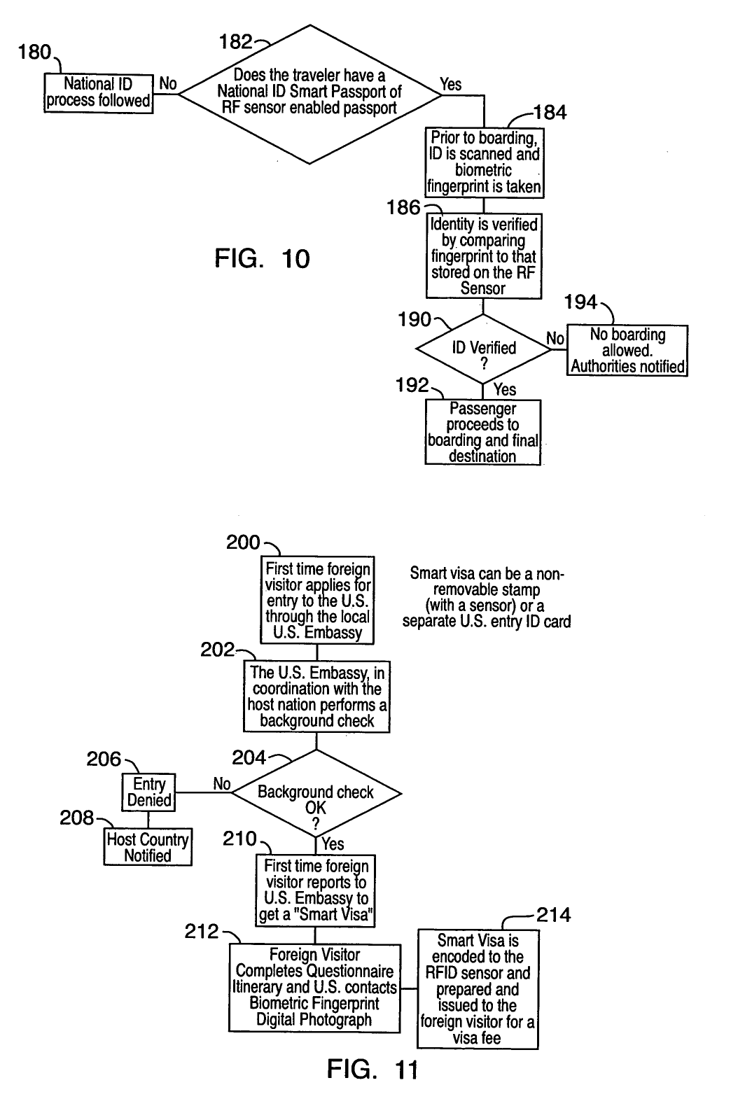

As shown in FIG. 10, the system can be used for domestic travel wherein the traveler proves identity at the point of boarding using the smart ID and its stored biometric and other data. As such, the identification process as described above is followed in a step 180. If the process is not followed, a query 182 is made to determine if the traveler has a smart ID or RF signal device-enabled passport. If he does, then the ID is scanned in a scanning step 184 prior to boarding a vessel. Also, biometric fingerprint data may be taken at this point. The traveler's identity is verified in a verification step 186, and a query 190 is executed to determine if the identity is valid. If the identify is valid, the traveler is allowed to board the vessel in a boarding step 192. If the identity can not be validated, however, the person is detained and the authorities are notified in an alert step 194. Any traveler not having a smart ID may have his conventional passport supplemented by a microchip.

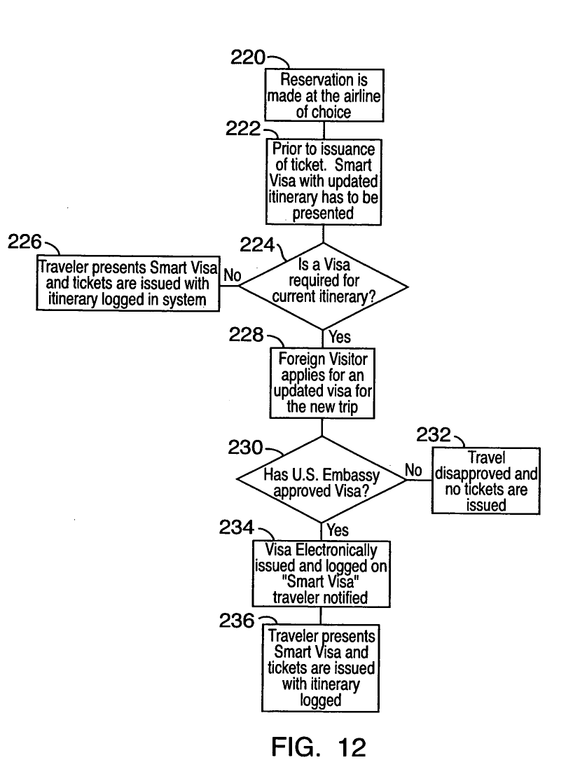

Referring now to FIGS. 11 and 12, the use of similar technology and methods to issue and process a travel visa to a foreign visitor is described. Essentially, the “smart visa” information and data is compared to the data stored on the database linked between the traveler's home country and the country to which he or she is traveling through a computer network. The data is processed and stored at the local embassy via the network. In FIG. 11, a first-time foreign visitor applies for entry to the U.S. through a U.S. embassy in the visitor's home country in an application step 200. The U.S. embassy, in coordination with the host nation, performs a background check in a check step 202. A query 204 determines if the background check meets an acceptable level of security. If it is determined that the visitor does not meet the criteria for entry into the U.S., his entry is denied in a deny step 206, and his host country is notified in a notification step 208. If, on the other hand, it is determined that the visitor does meet the criteria for U.S. entry, the visitor reports to the U.S. embassy to obtain his smart visa in an obtaining step 210. A questionnaire is completed in an interview step 212 to ascertain the visitor's itinerary and U.S. contacts and to obtain the relevant biometric data and photograph. The smart visa is then encoded in an issue step 214 and issued to the visitor.

In FIG. 12, the visitor makes a reservation with an available carrier in a reservation step 220. The smart visa with the relevant itinerary is presented and, if acceptable, the visitor's visa is updated in an update step 222. A query 224 is then made to determine if a visa is required for the current itinerary. If a visa is not required, the visitor presents the smart visa and tickets are issued with the visitor's itinerary being logged into the system in a logging step 226. If a visa is required, then the visitor applies for an updated visa in an application step 228. A query 230 is made to determine if the U.S. embassy has approved the visa. If the visa has not been approved, travel is disapproved in a disapproval step 232 and no tickets are issued. If the visa has been approved, then the visa is electronically issued in an issue step 234. The relevant information is logged and the visitor is notified. In a ticketing step 236, the visitor presents the smart visa and tickets are issued with the itinerary being logged in the proper database.

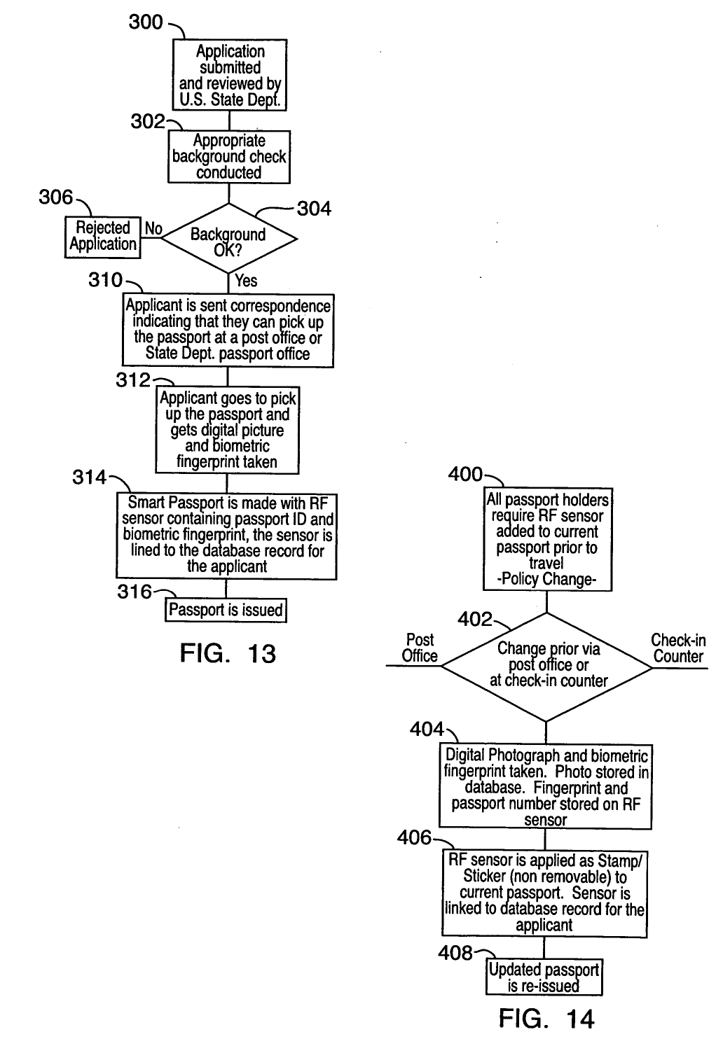

The flow diagram of FIG. 13 shows in detail the procedure for issuance of a new “smart passport” or the renewal thereof to a local citizen (a U.S. citizen in this example). Essentially, similar data and means for obtaining and storing the same as described above with reference to the “smart ID” are implemented, and the smart passport is utilized in place of a conventional passport. In this procedure, a traveler submits an application for review by the U.S. State Department in a submit step 300. The appropriate background check is conducted in a check step 302. A query 304 is then made to determine if the background check meets acceptable established criteria. If it does not meet acceptable established criteria, then the application is rejected in a rejection step 306. If the background check does meet acceptable established criteria, then a notification step 310 indicates to the traveler that his smart passport can be obtained at a designated office. The traveler then proceeds to the designated office where he submits to having his biometric fingerprint and photograph taken in a step 312. The smart passport is then assembled in an assembly step 314 to have the pertinent information included as well as any sensing device incorporated therein. The sensing device information is linked to a database. The smart passport is then issued to the traveler in an issue step 316.

The flow diagram of FIG. 14 shows in detail how a conventional passport can be retrofitted with a microchip. In a policy change step 400, a passport holder is required to have an RF signal device added to his current passport. An option 402 may be given to provide for the change to be made at either a U.S. Post Office or some other designated location. After reporting to the designated location, a step 404 is executed in which the passport holder has his photograph and biometric fingerprint data taken, stored in a database, and incorporated into the RF signal device. The RF signal device is then applied as a stamp or sticker in an application step 406. Preferably, the stamp or sticker is applied so as to be non-removable from the passport. The signal device is then linked to the database record for the applicant (passport holder). In a re-issue step 408, the updated passport is passed to the passport holder.

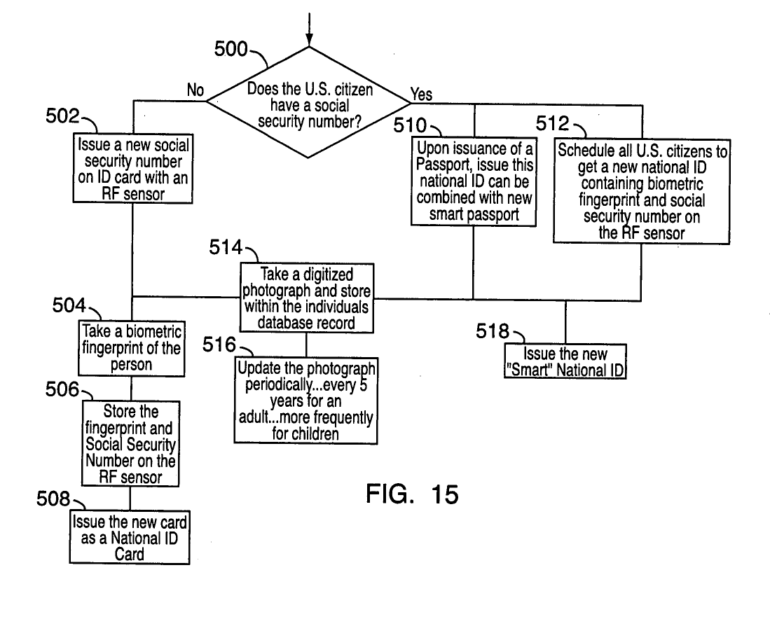

The flow diagram of FIG. 15 describes a procedure for issuance of a “national ID” in accordance with the present invention. The national ID is essentially the same as the “smart ID” referred to above and can be issued to all citizens using social security number as one of numerous identifiers. Additional identifiers include digitized biometric data such as thumbprint, facial recognition and the like. In the issuance of a national ID, a query 500 is made to ascertain whether the person has a social security number. If the person does not have a social security number, an issue step 502 is executed in which a new social security number on ID card having an RF signal device is issued. A biometric fingerprint of the person is then taken in a fingerprinting step 504, the fingerprint and social security number are then stored on the RF signal device in a storing step 506, and the card is issued as a national ID card in an issue step 508. In addition to the fingerprinting step 504, a person may submit to having his photograph taken in a photographing step 514. The photograph may be updated periodically in an update step 516, for example, every five years (more frequent updates may be made for children). If the person does have a social security number, the national ID can be combined with a smart passport in a combination step 510. Also, all U.S. citizens can be scheduled in a schedule step 512 to obtain a new national ID containing biometric fingerprint and social security number data on the RF signal device of the ID. In any scenario, once at least the relevant information is obtained, the national ID is issued in an issue step 518.

Although this invention has been shown and described with respect to the detailed embodiments thereof, it will be understood by those of skill in the art that various changes may be made and equivalents may be substituted for elements thereof without departing from the scope of the invention. For example, “individuals” as used herein is defined expansively beyond humans to include anything, which is capable of unique identification. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. An apparatus for use in providing secure and unique identification, said identification apparatus comprising:
a means for receiving electromagnetic data signals, said signals having a plurality of coded segments corresponding to select identifying parameter values;
a means for electromagnetically storing said data signals in a corresponding one of a plurality of data fields, said data fields including a identifier field adapted to receive signals uniquely identifying an individual and a travel field adapted to receive signals corresponding to parameter data related to movement of said individual from a first position to a second position.

2. The apparatus of claim 1 wherein said identifier field comprises a base alphanumeric field for recording alphanumeric data corresponding to the alphanumeric identifier data and a biometric field for recording information corresponding to a biometric identifier data.

3. The apparatus of claim 1 wherein in said travel related field further comprises a secure passport field receiving signals corresponding to government passport data and a read-writable travel field adapted to receive signals identifying arrival of the individual at a specific geographic location.

4. The apparatus of claim 2 wherein said base alpha numeric field is adapted to receive signals corresponding to an individual's name, address, and government issued identifying data.

5. The apparatus of claim 2 wherein said biometric field is adapted to received signals corresponding to a fingerprint of the individual.

6. The apparatus of claim 1 wherein said travel field is adapted to receive signals corresponding to date and port of entry to a country and date and port of exit from a country.

7. A system for use in tracking and identifying individuals, said system comprising:
an electromagnetic identification apparatus, having a plurality of data fields, each of said data fields adapted to receive signals which uniquely identify an individual;
a writer for use in encoding said identification signals into said electromagnetic identification apparatus data fields;
a controller for receiving signals uniquely identifying an individual coded on said electromagnetic identification apparatus and storing said individual identification signals in a master database storage apparatus; and
a reader adapted to interrogate the unique individual identification signals stored on said electromagnetic identification apparatus and for communicating with said controller for comparing corresponding individual identification signals stored on said master database storage apparatus with signals received from said electromagnetic identification apparatus and generating an alarm signal should said comparison reveal a discrepancy.

8. The system of claim 7 wherein said writer further comprises means for selecting write enabled data fields of said electromagnetic identification apparatus and recording signals only therein.

9. The system of claim 7 wherein said electromagnetic identification apparatus further comprises a plurality of distinct fields each adapted to receive signals corresponding to alphanumeric identification data, biometric identification data, passport data, and data indicative of entry and exit of the individual from a country.

10. The system of claim 7 wherein said writer further comprises a means for augmenting data in said alphanumeric field.

11. The system of claim 7 wherein said controller further comprises a means for examining the content of stored signals indicative of individuals scheduled to exit a port on a select date and, after said select date, comparing said signals with signals corresponding to individuals actually recorded exiting said exit port on a said select date and generating an alarm signal therefrom should a discrepancy be found between individuals scheduled to exit said port and those individuals recorded leaving said port.

12. The system according to claim 7 wherein said controller further comprises a means for receiving a plurality of sets of identification signals from a reader positioned at a select port, said received reader signals corresponding to individuals entering that port at a select time period and signals corresponding to individuals exiting said port in a select time period.

13. The system of claim 7 further comprising an electromagnetic read-write apparatus adapted to communicate with a plurality of electromagnetic identification apparatus corresponding to a specific set of individuals;
said read-write apparatus including means for polling data fields on said electromagnetic identification apparatus and recording signals identifying each individual; and
means for forwarding said recorded individual signals on said master database storage apparatus and including a write apparatus for encoding data and signals in corresponding to the date and port on electromagnetic identification apparatus for each individual exiting the port.

14. The electromagnetic identification apparatus of claim 7 further comprising a data field accessible by non-governmental entities.

15. The system of claim 1 wherein said electromagnetic identification apparatus comprises a RFID tag.

16. The system of claim 15 wherein said RFID tag is a passive tag having a range of up to 13 feet and operating at about 915 MHz.

17. The system of claim 7 wherein said reader comprises an Intermec IP3 portable reader platform.
